(19) United States
(12) Patent Application Publication
(10) Pub. No.: US 2018/0057093 A1
(43) Pub. Date: Mar. 1, 2018

(54) HANDLEBAR MOUNTED TOOL SYSTEM AND METHOD OF USE

(71) Applicant: Todd N. Lenig, Ankeny, IA (US)

(72) Inventor: Todd N. Lenig, Ankeny, IA (US)

(21) Appl. No.: 15/684,575

(22) Filed: Aug. 23, 2017

Related U.S. Application Data
(60) Provisional application No. 62/378,982, filed on Aug. 24, 2016.

(51) Int. Cl. B62J 9/02; B25B 27/00; B25B 15/02

(52) U.S. Cl. CPC B62J 9/02; B25B 15/02; B25B 27/0071

(57) ABSTRACT

A multi-purpose tool system installed on the handle bars of a conventional bicycle. The tool system is formed of a main body, and an expansion mechanism, a plug and a fastener. The expansion mechanism is inserted in an open end of a handle bar of a bicycle and the fastener is tightened. This causes the expansion mechanism to expand and tighten against the interior surface of the handle bars thereby holding it in place. The expansion mechanism is formed of a plurality of wedges that are held together by binders. The main body holds a plurality of bits and a cover that includes a driver is connected to the main body by a locking mechanism. When a tool is needed, the cover is removed from the main body, a bit is removed from the main body and inserted into the driver and the cover is used as a handle.

### CROSS REFERENCE TO RELATED APPLICATIONS

This application claims priority to U.S. Patent and Trademark Application No. 62/378,982 which was filed on Aug. 24, 2016 which contents are incorporated by reference herein.

### FIELD OF THE INVENTION

This invention relates to tools. More specifically, and without limitation, this invention relates to a multi-purpose tool system that can be attached to any opening, such as the opening in the end of a handle bar of a bicycle.

### BACKGROUND OF THE INVENTION

Bicyclists and other people who are on the go often find themselves in the need for various tools. Taking bicyclists as one example, unfortunately tools are often needed when the user is far away from their tools. Making matters worse, since an unanticipated breakdown is exactly that—unanticipated, it is impossible to predict what tools are needed.

To solve this problem, countless forms of multi-purpose tool systems have been developed for bicyclists, campers, hunters, and the like such as Leatherman tools, Swiss army knives among other multi-function multi-purpose tools.

While some of these tool systems are somewhat effective, all of these multi-purpose tools suffer from the same disadvantage. That is, where do you put them on a bicycle.

To solve this problem many bicyclists place a small bag under their seat. While somewhat effective, using a bag has disadvantages. Bags tend to get in the way, they are easily left open for the contents to spill out during a ride and often tools that are place in the bag are removed or lost over time when other more-important objects are place in the bag like a credit card, money, an ID or cell phone. As such, many times when a bicyclist needs a tool, it has unfortunately been removed from their bag either intentionally or unintentionally.

Therefore, in view of the disadvantages in the prior art, for the reasons stated above, and for other reasons stated below which will become apparent to those skilled in the art upon reading and understanding the specification, claims and drawings there is a need in the art for a handlebar mounted tool system and method of use.

Thus, it is a primary object of the invention to provide a handlebar mounted tool system and method of use that improves upon the state of the art.

Another object of the invention is to provide a handlebar mounted tool system and method of use that is convenient to use.

Yet another object of the invention is to provide a handlebar mounted tool system and method of use that is hard to misplace or leave behind.

Another object of the invention is to provide a handlebar mounted tool system and method of use that can easily be attached to various devices such as bicycles.

Yet another object of the invention is to provide a handlebar mounted tool system and method of use that is durable.

Another object of the invention is to provide a handlebar mounted tool system and method of use that has a long useful life.

Yet another object of the invention is to provide a handlebar mounted tool system and method of use that has an intuitive design.

Another object of the invention is to provide a handlebar mounted tool system and method of use that is formed of a minimum number of parts.

Yet another object of the invention is to provide a handlebar mounted tool system and method of use that has a rugged design.

Another object of the invention is to provide a handlebar mounted tool system and method of use that is light weight.

Yet another object of the invention is to provide a handlebar mounted tool system and method of use that is relatively inexpensive to manufacture.

Another object of the invention is to provide a handlebar mounted tool system and method of use that provides value, utility and novelty to the user.

Yet another object of the invention is to provide a handlebar mounted tool system and method of use that can easily and efficiently be used to fix a problem in a convenient manner.

Another object of the invention is to provide a handlebar mounted tool system and method of use that is sized and shaped to be quickly and easily installed on conventional handle bars of bicycles.

Yet another object of the invention is to provide a handlebar mounted tool system and method of use that is adjustable.

Another object of the invention is to provide a handlebar mounted tool system and method of use that provides for a convenient place for advertising and promotion.

Yet another object of the invention is to provide a handlebar mounted tool system and method of use that provides cross-branding and promotional opportunities.

Another object of the invention is to provide a handlebar mounted tool system and method of use that can be easily removed and reinstalled.

Yet another object of the invention is to provide a handlebar mounted tool system and method of use that can be installed into practically any suitable opening or hole.

Another object of the invention is to provide a handlebar mounted tool system and method of use that holds a plurality of tools.

Yet another object of the invention is to provide a handlebar mounted tool system and method of use that is safe.

Another object of the invention is to provide a handlebar mounted tool system and method of use that improves safety by providing a useful tool to the user.

These and other objects, features, or advantages of the invention will become apparent from the specification, claims and drawings.

### SUMMARY OF THE INVENTION

A multi-purpose tool system installed on the handle bars of a conventional bicycle. The tool system is formed of a main body, and an expansion mechanism, a plug and a fastener. The expansion mechanism is inserted in an open end of a handle bar of a bicycle and the fastener is tightened. This causes the expansion mechanism to expand and tighten against the interior surface of the handle bars thereby holding it in place. The expansion mechanism is formed of a plurality of wedges that are held together by binders. The main body holds a plurality of bits and a cover that includes a driver is connected to the main body by a locking mechanism. When a tool is needed, the cover is removed from the main body, a bit is removed from the main body and inserted into the driver and the cover is used as a handle.

### BRIEF DESCRIPTION OF THE DRAWINGS

FIG. 1 is an exploded perspective view of a multi-purpose tool system for installation on the handle bars of a conventional bicycle, the view showing a driver for use with a plurality of bits that are held by the system;

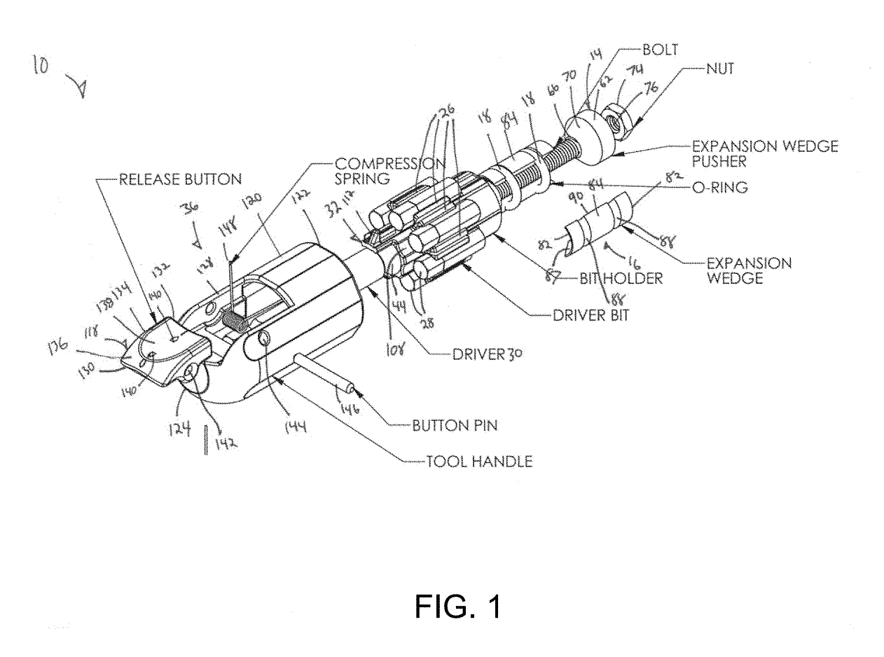

FIG. 2 is a side elevation cut-away view of the multi-purpose tool system shown in FIG. 1, the view showing the multi-purpose tool system in an assembled state;

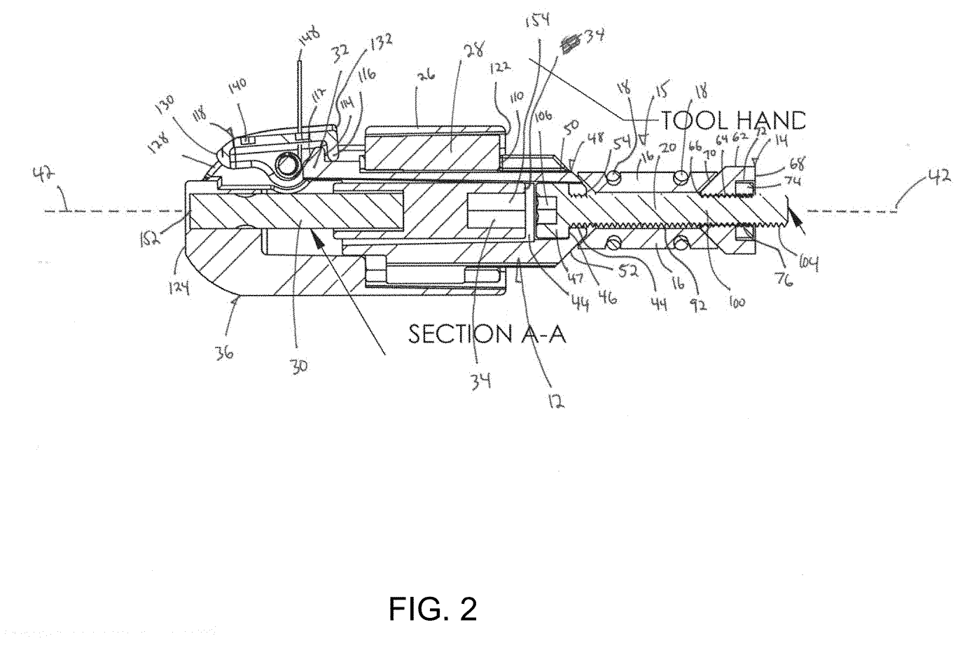

FIG. 3 is a side elevation exploded view of the multi-purpose tool system shown in FIGS. 1 and 2;

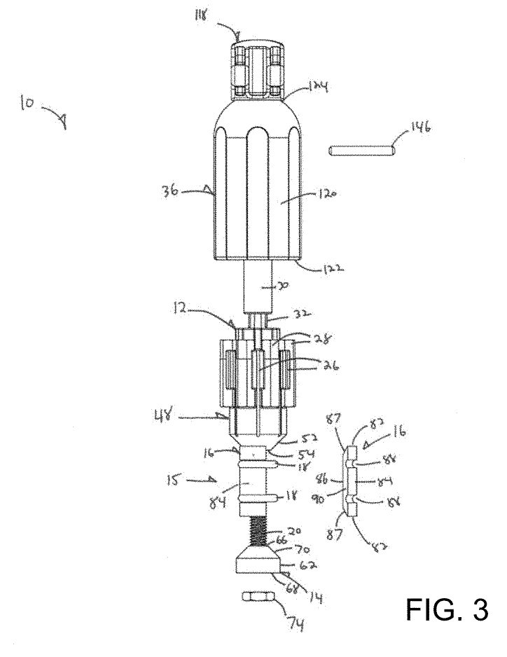

FIG. 4 is a side elevation view of the multi-purpose tool system shown in FIGS. 1-3, the view showing the multi-purpose tool system in an assembled state, the view showing the side of the multi-purpose tool system;

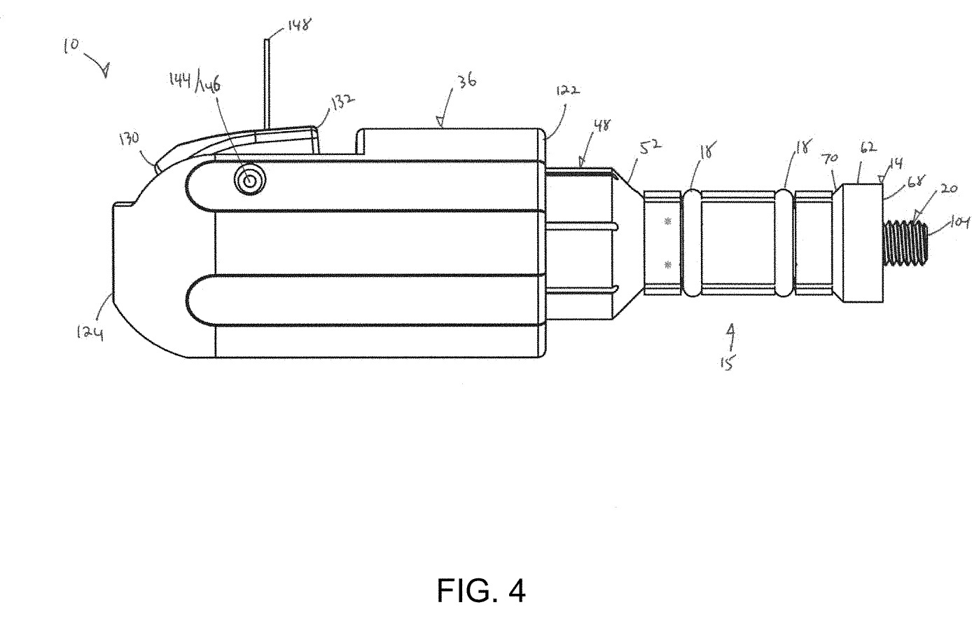

FIG. 5 is a side elevation view of the multi-purpose tool system shown in FIGS. 1-4, the view showing the multi-purpose tool system in an assembled state, the view showing the top side of the multi-purpose tool system;

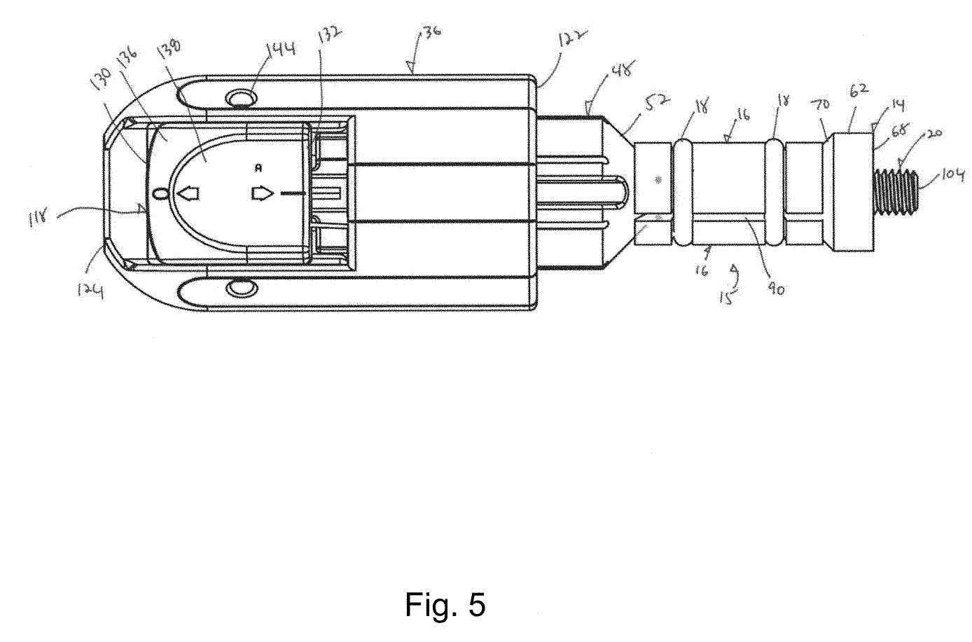

FIG. 6 is a perspective view of the multi-purpose tool system shown in FIGS. 1-5, the view showing the multi-purpose tool system in an assembled state, the view showing the top side of the multi-purpose tool system;

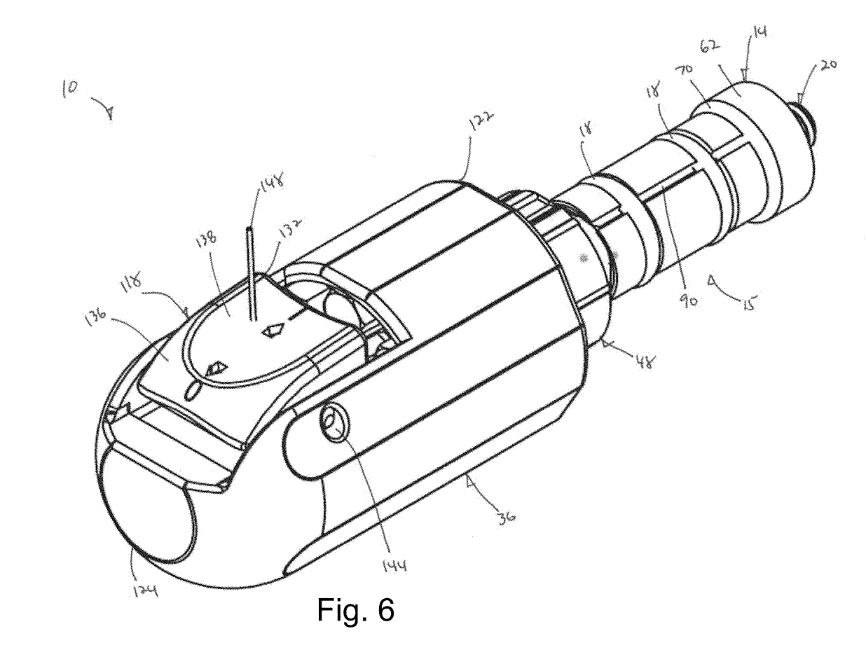

FIG. 7 is an end elevation view of the multi-purpose tool system shown in FIGS. 1-6, the view showing the multi-purpose tool system in an assembled state;

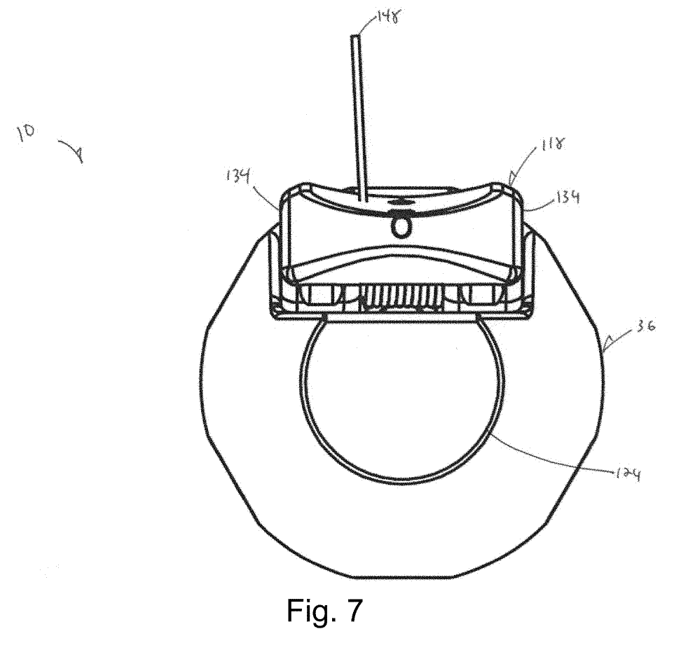

FIG. 8 is an exploded perspective view of an expansion mechanism for use with the multi-purpose tool system shown in FIGS. 1-7, the view showing the wedges in an exploded state;

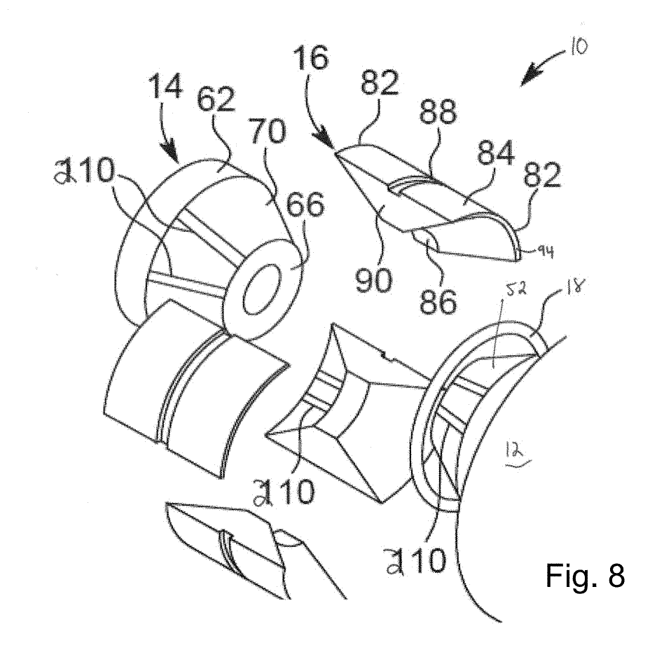

FIG. 9 is an perspective view of a wedge of an expansion mechanism for use with the multi-purpose tool system shown in FIGS. 1-8, the view showing the wedges in an exploded state;

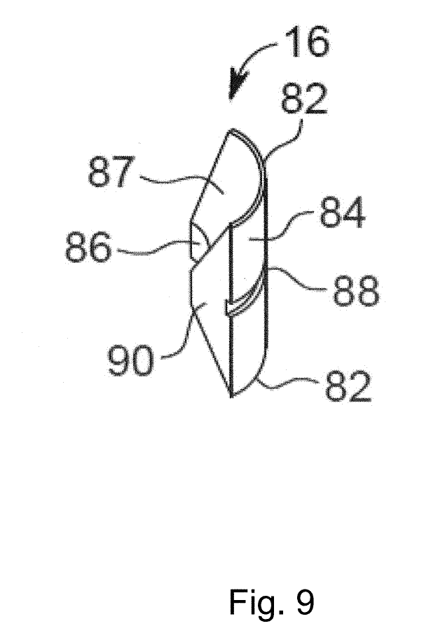

FIG. 10 is an elevation view of an end of a wedge of an expansion mechanism for use with the multi-purpose tool system shown in FIGS. 1-9;

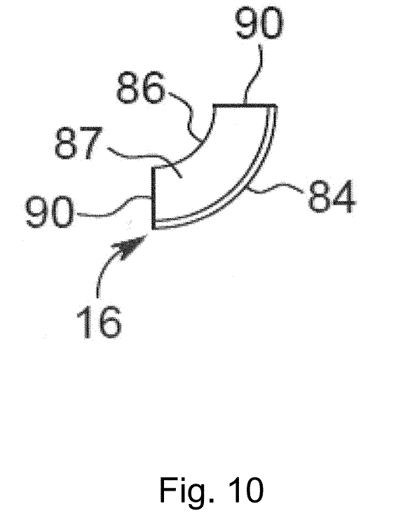

FIG. 11 is a side elevation view, an end elevation view and a perspective view of a plug of an expansion mechanism for use with the multi-purpose tool system shown in FIGS. 1-10;

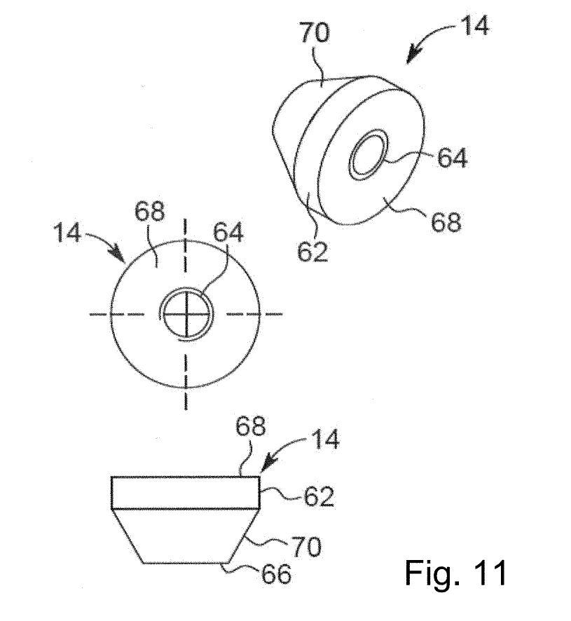

FIG. 12 is a rear perspective exploded view of the multi-purpose tool system shown in FIGS. 1-11;

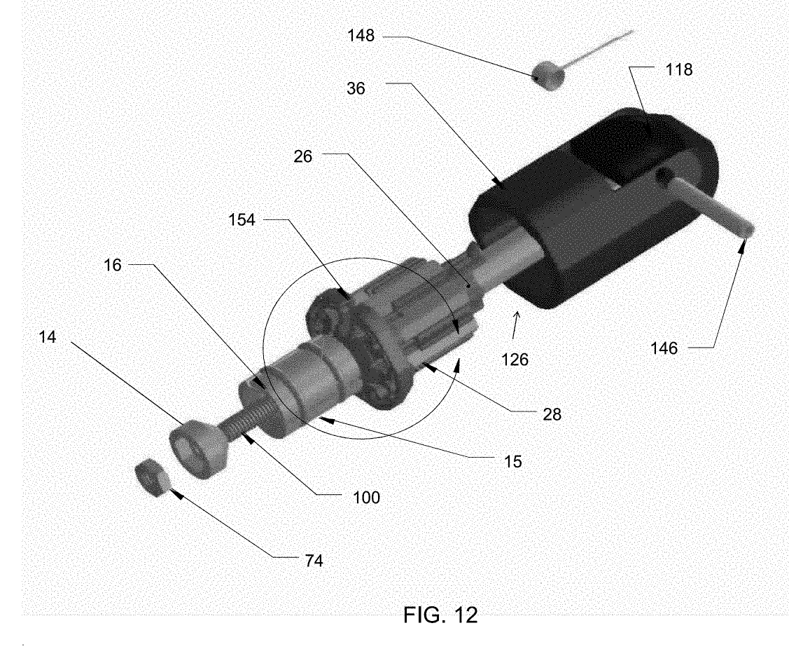

FIG. 13 is a rear close up perspective view of a portion of the multi-purpose tool system shown in the circular cut out indicated on FIG. 12;

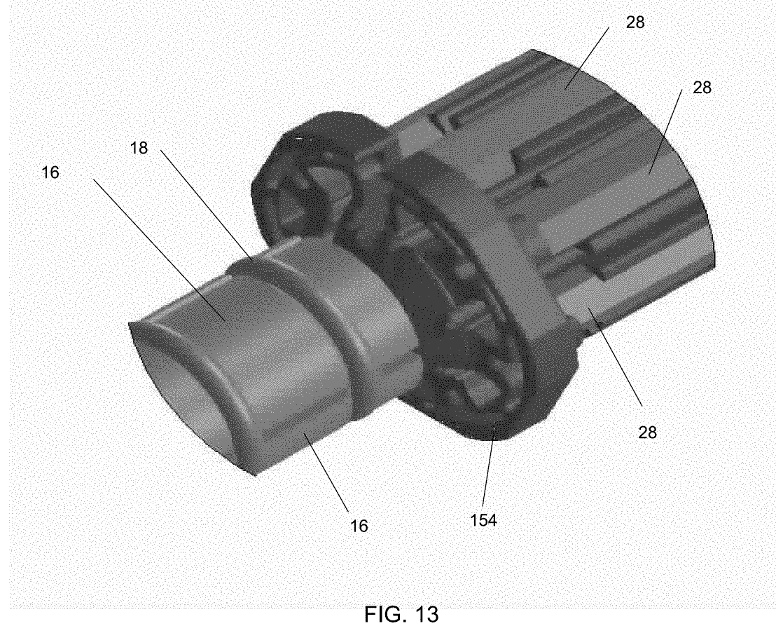

FIG. 14 is a perspective view of an alternative arrangement, the view showing a main body that houses at least one battery therein, the main body having a narrower portion and a wider portion, the view showing the exterior end of the wider portion of the main body having a pair of ports, one USB port and one Micro-USB port, and a light therein;

FIG. 15 is a side elevation view of the alternative arrangement show in FIG. 14, the view showing a main body having a narrower portion and a wider portion.

### DETAILED DESCRIPTION OF THE PREFERRED EMBODIMENT

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention. The following detailed description is, therefore, not to be taken in a limiting sense, and the scope of the invention is defined only by the appended claims, along with the full scope of equivalents to which such claims are entitled.

As used herein, the terminology such as vertical, horizontal, top, bottom, front, back, end, sides, and the like, are referenced according to the views presented. It should be understood, however, that the terms are used only for purposes of description, and are not intended to be used as limitations. Accordingly, orientation of an object or a combination of objects may change without departing from the scope of the invention.

System:

With reference to the figures, handlebar mounted tool system 10 is presented. The system 10 includes the component pieces of a main body 12, a plug 14, and an expansion mechanism 15 formed of a plurality of wedges 16, at least one elastic binder 18 and a fastener 20. The system 10 connects to the interior diameter of a tube 22, such as that which forms handle bars on a conventional bicycle 24 or any other circular opening. Main body 12 includes a plurality of bit holders 26 that are configured to hold bits 28 or other tools or devices. A driver 30 is removably connected to the main body 12 by locking mechanism 32. Driver 30 includes a socket 34 configured to receiver bits 28 therein. A cover 36 is connected to driver 30 and is configured to cover main body 12 when driver 30 is not in use and in a stored position over main body 12, and to serve as a handle when driver 30 is used.

Main Body:

The main body 12 is formed of any suitable size, shape and design. In one arrangement, as is shown, main body 12 is generally cylindrical in shape and is elongated and extends a distance from a rearward end or inward end to an forward end or outward end. In this arrangement, main body 12 includes a center axis 42 that extends through the center of main body 12.

A bore 44 extends through main body 12. Bore 44 is formed of any suitable size, shape and design. In the arrangement shown, bore 44 is generally cylindrical in shape and is approximately centrally positioned within main body 12 and aligned with center axis 42. That is, bore 44 extends in a generally parallel arrangement to the length of main body 12. A shoulder 46 is positioned a distance inward from the inward or rearward most end of main body 12. Shoulder 46 transitions bore 44 from a narrower diameter to a wider diameter and serves to engage and retain a head 47 of fastener 20. In this way, shoulder 46 prevents head 47 of fastener 20 from passing through bore 44 of main body 12.

A protrusion 48 extends outward from the inward most end of main body 12. Protrusion 48 is formed of any suitable size, shape and design. In the arrangement shown, protrusion 48 is generally cylindrical in nature and is centered on center axis 42 and includes a generally cylindrical exterior surface 50. The inward end of protrusion 48 includes a ramp 52. Ramp 52 is an angled surface or cone-shaped surface that extends inward at an angle towards the centrally positioned centered axis 42. In this way, ramp 52 forms a partial portion of a cone that gets narrower as it extends rearward. The rearward edge of ramp 52 connects to rear wall 54. Rear wall 54 defines a plane that is positioned in generally parallel spaced relation to the plane defined by shoulder 46, and is positioned in a generally perpendicular arrangement to the length of bore 44 and central axis 42.

Plug:

System 10 includes a plug 14. Plug 14 is formed of any suitable size, shape and design. In the arrangement shown, plug 14 is formed of a similar size and shape as protrusion 48, only oppositely positioned and unattached to main body 12.

That is, plug 14 is generally cylindrical in nature having a cylindrical exterior surface 62 and a cylindrical bore 64 extending through its middle from front wall 66 to rear wall 68.

The cylindrical exterior surface 62 of plug 14 is positioned in approximate perpendicular relation to plane formed by front wall 66 and rear wall 68. The rear edge of exterior surface 62 connects to rear wall 68 at an approximate perpendicular orientation. The forward edge of exterior surface 62 connects to ramp 70. Ramp 70 extends inward at an angle from cylindrical exterior surface 62 towards the centrally positioned bore 64 and centered axis 42. In this way, ramp 70 forms a partial portion of a cone that gets narrower as it extends forward. The forward edge of ramp 70 connects to front wall 66. Front wall 66 defines a plane that is positioned in generally parallel spaced relation to the plane defined by rear wall 68, and is positioned in a generally perpendicular arrangement to exterior surface 62.

In the arrangement shown, the size and shape of front wall 66 of plug 14 corresponds the size and shape of rear wall 54 of main body 12. Similarly, the size and shape of ramp 70 of plug 14 corresponds to the size and shape of ramp 52 of main body 12. Similarly, the size and shape of exterior surface 62 of plug 14 corresponds to the size and shape of the exterior surface 50 of protrusion 48 of main body 12. Similarly, the size and shape of bore 64 of plug 14 corresponds to the size and shape of bore 44 of main body 12. In this way, plug 14 and protrusion 48 are similar in size and shape in many ways, and in some arrangements they are identical or approximate mirror images of one another.

In one arrangement, plug 14 includes a socket 72 positioned in its rear wall 68. Socket 72 is sized and shaped to receive and hold a nut 74 therein. In one arrangement, socket 72 and nut 74 are sized and shaped to fit together in mating and non-rotational manner. That is, as one example, the exterior surface of nut 74 is hexagonal in shape and the interior surface of socket 72 is similarly hexagonal in shape such that when the nut 74 is positioned within socket 72 it is held therein and the two components rotate together or are non-rotational with respect to one another. Nut 74 includes a threaded bore 76 therein that is sized and shaped to mate with the threaded end of fastener 20. By including socket 72 in plug 14 and using a separate nut 74 this allows plug 14 and nut 74 to be formed of different materials such as forming plug 14 out of cheaper and easier to manufacture plastic while nut 74 is formed of a metallic material which is stronger and more durable than plastic. Alternatively, plug 14 and nut 74 are formed of a single unitary piece of material and are formed of the same material and the bore 64 of plug 14 includes threads that mate with the threaded end of fastener 20. Alternatively, the rear wall 68 of plug 14 is flat and nut 74 is positioned behind and in engagement with rear wall 68 without the use of socket 72.

Expansion Mechanism:

System 10 includes an expansion mechanism 15 which is designed to expand in functional diameter as the plug 14 moves closer to the main body 12, and shrink in functional diameter as the plug 14 moves away from the main body 12. Expansion mechanism 15 is formed of any suitable size shape and design and serves to lock system 10 into place, such as onto or into the hollow tube 22 of the handle bar of a bicycle, however expansion mechanism 15 can be used to connect to any opening.

In one arrangement, as is shown, expansion mechanism 15 is formed of one or more wedges 16. Wedges 16 are formed of any suitable size, shape and design. In the arrangement shown, wedges 16 are formed of a partial portion of a cylinder. In the arrangement shown, three or four wedges 16 are used each wedge being identical or approximately identical to one another and each wedge 16 forming approximately one third or 120° of the cylinder or one quarter or 90° of the cylinder that is formed out of all wedges 16 when placed together. However, any other number of wedges are hereby contemplated for use, such as only one, two, three, four, five, six, seven, eight, nine, ten or more.

Wedges 16 are symmetric or approximately symmetric about a plane that extends through their middle from side-to-side, as well as through their middle from front-to-back. Wedges 16 extend forward to back a length from opposing end 82 to opposing end 82. Wedges 16 have a cylindrical exterior surface 84 and cylindrical interior surface 86. A ramp 87 extends at an angle from ends 82 from the exterior surface 84 to the interior surface 86. The cylindrical exterior surface 84 and the cylindrical exterior surface 86 are positioned in approximate parallel spaced relation to one another. In this way, the cylindrical interior surface 86 has a smaller diameter than the cylindrical exterior surface 84. In addition, the cylindrical interior surface 86 is narrower, forward to back, than the cylindrical exterior surface 84 due to the angled ends that are further described herein.

One or more grooves 88 are positioned in the cylindrical exterior surface 84. In one arrangement, a single groove 88 is positioned approximately at the midpoint between opposing ends 82 thereby providing balance to the expansion mechanism 15 when only a single groove 88 is used. In another arrangement, two grooves 88 are used, each positioned a distance inward from opposing ends 82, again providing balance to expansion mechanism 15. Groove 88 extends in approximate parallel spaced relation to the opposing ends 82 and serves to receive binder 18 or other elastic member therein.

Wedges 16 terminate at sides 90 which are generally flat and planar in shape. In the arrangement shown, when four wedges 16 are used, the planes that are defined by sides 90 are positioned at approximate perpendicular alignment to one another, or said another way, the sides 90 are at 90° to one another, however this angle changes when more or less wedges are used. When three wedges 16 are used, then sides 90 are positioned at 120° to one another. When two wedges 16 are used, then sides 90 are positioned at 180° to one another. And so on.

When wedges 16 are positioned in flush side 90 to side 90 alignment, the interior surfaces 86 of adjacent wedges 16 define a bore 92 that is similar to, identical to, or just slightly larger than the bores 44, 64 in main body 12 and plug 16 respectively. Also, in this arrangement, the grooves 88 of adjacent wedges 16 align with one another to form a single continuous groove all the way around all wedges 88, and the ends 82 align with one another.

Once aligned in this side 90 to side 90 alignment, binder 18 is positioned in grooves 88, thereby holding all wedges 16 together. In this arrangement, the binder 18 holds the plurality of wedges 16 together to form the partial portion of a cylinder. This partial portion of a cylinder has a cylindrical exterior surface 84, and cylindrical interior surface 86 (that accommodates the passage of fastener 20 there through) and angled edges, or ramps 87, that extend from the ends 82 to the interior surface 86. Also, the ramps 87 of wedges 16 are positioned at an angle that is similar or identical to the ramps 52 of main body 12 as well as the ramps 70 of plug 14. In one arrangement, to prevent ends 82 from being sharp due to the direct intersection of angled ramp 70 with exterior surface 84, this intersection is chamfered, trimmed or said another way a small wall 94 connects exterior surface 84 to angled ramp 87. In the arrangement, each end 82 includes wall 94 which are positioned in approximate parallel spaced relation to one another and are positioned in approximate perpendicular alignment to the exterior surface 84 of wedges 16.

Binders 18 are formed of any device such as a flexible O-ring, rubber band or any other flexible device that is resilient and has a tendency to pull the adjacent wedges 16 together while allowing separation of the wedges 16 from one another when force is applied when plug 14 is pulled toward main body 12.

Fastener:

System 10 also includes fastener 20. Fastener 20 is formed of any suitable size, shape and design. In the arrangement shown, fastener 20 is formed of a screw or bolt or similar device that includes an elongated shaft 100 having a head 47 at its forward most end and terminates at a threaded end 104. The diameter of head 47 is sized and shaped to be received within bore 44 of main body 12 prior to shoulder 46. That is, shaft 100 extends through the main body 12 while head 47 is stopped by or caught by shoulder 46. When head 47 engages shoulder 46, fastener 20 is fully inserted within main body 12. Head 47 also includes a feature 106 that is used for rotating fastener 20 such as a hex-head feature, square-head feature, Philips-head feature, flat-head feature or any other feature that is used to rotate shaft 20. In the arrangement shown, feature is recessed within head 47 such that the exterior surface of head 47 is cylindrical in shape and in this way allows for rotation of head 47 within bore 44. Alternatively, the exterior surface of head 47 includes feature 106 that facilitates rotation, such as being a hex-head or similar shape.

Installation:

A plurality of wedges 16 are positioned in side 90 to side 90 alignment thereby forming a partial portion of a cylinder having inwardly sloped ends that connect to or funnel toward a central bore. Once aligned in this manner, binders 18 are positioned around all the wedges 16 in grooves 88 thereby holding the wedges 16 together and forming the expansion mechanism 15.

Plug 14 is positioned at the rearward end 82 of the connected wedges 16. In this position the ramped rearward surface 87 of wedges 16 are in approximate flush alignment with and engagement with the ramped forward surface 70 of plug 14. Also, in this arrangement the bore 64 of plug 14 aligns with the bore 92 formed by the interior surfaces 86 of wedges 16.

Protrusion 48 of main body 12 is positioned at the forward end 82 of the connected wedges 16. In this position the rearward ramped surface 52 of protrusion 48 is in approximate flush alignment with and engagement with the forward ramped surfaces 87 of wedges 16. Also, in this arrangement the bore 44 of main body 12 aligns with the bore 92 formed by the interior surfaces 86 of wedges 16, as well as being aligned with the bore 64 of plug 14.

Once the connected wedges 16, plug 14 and main body 12 are positioned in central alignment with one another around center axis 42, fastener 20 is inserted through the components: main body 12, expansion mechanism 15 and plug 14 thereby connecting them together. More specifically, the threaded end 104 of fastener 20 is inserted into bore 44 of main body 12 until head 47 engages shoulder 46. At this point, the threads of threaded end 104 of fastener 20 engage the threads in the bore 64 of plug 14 or the bore 76 of nut 74 and the fastener 20 is rotated by feature 106 thereby threadably engaging the two components, fastener 20 and plug 14/nut 74, together.

As the fastener 20 is rotated in one direction the plug 14 is pulled towards the main body 12. This forces the ramped surfaces 87 of wedges 16 over the ramped surface 52 of protrusion 48 and the ramped surface 70 of plug 14. As the plug 16 is pulled closer and closer to the main body 12 by fastener 20 the wedges 16 are forced to expand further and further away from one another.

When the plug 14, expansion mechanism 15 and protrusion 48 of main body 12 are positioned within the open end of tube 22 of handle bars of a bicycle 24 and the fastener 20 is tightened, this causes the wedges 16 to expand until the exterior surface 84 of the wedges 16 engage the interior surface of the tube 22 of the handle bars. In this way, the system 10 is attached to the bicycle 24 (or any other hollow opening).

In this way, the use of expansion mechanism 15 allows for the quick and easy and rigid and durable installation of system 10 to any opening.

Removal:

To remove the system 10, the opposite process is performed. That is, the fastener 20 is rotated in the opposite direction it was rotated to install the system 10. As the fastener 20 is rotated, the plug 14 moves rearward in relation to the main body 12. As the plug 14 moves rearward the ramped surfaces 87 of wedges 16 slide downward over the ramped surface 52 of protrusion 48 and the ramped surface 70 of plug 14. This is caused by the inward resilient pull of binders 18 around expansion mechanism 15. Once the fastener 20 has been rotated far enough for the diameter of expansion mechanism 15 to diminish to a point where the exterior surface 84 of wedges 16 no longer engage the interior surface of tube 22 of the handle bars of bicycle 24 the system 10 can be removed.

In this way, the use of expansion mechanism 15 allows for the quick and easy removal of system 10 to any opening.

Bits & Bit Holders:

The portion of main body 12 forward of rearward positioned protrusion 48 includes a plurality of bit holders 26 positioned around the exterior circumference of main body 12. Bit holders 26 are positioned on a relatively thin piece of material that occupies the space between the exterior surface of main body 12 and the bore 44 that extends through main body 12.

Bit holders 26 are formed of any suitable size, shape and design and are configured to receive and hold bits 28 therein. In one arrangement, as is shown, bit holders 26 are formed of a pair of opposing flexible arms that define an opening there between. Bit holders 26 are sized and shaped to receive conventional hexagonal driver bits 28 therein. In one arrangement, the opening formed by bit holders 26 is hexagonal in shape and is sized to matingly receive and frictionally hold a hexagonal bit 28 therein. In another arrangement, the opening formed by bit holders 26 is generally circular in shape and sized to frictionally hold a hexagonal bit 28 therein. In one arrangement, flexible arms of bit holder 26 are biased inward toward one another such that they apply an inward force on bits 28 when positioned within bit holder 26. To help minimize the exterior diameter of main body 12 while maximizing the amount of bits 28 held thereto, recesses 108 are positioned in main body 12 between the flexible arm of bit holders 26. These recesses 108 are configured to provide additional room for bits 28 therein when held within bit holders 26 and allow the exterior diameter of main body 12 to be at a minimum while holding a maximum number of bits 28 therein.

In one arrangement, bits 28 can be installed into bit holders 26 by aligning the bits 28 with a recess 108 and sliding bits 28 rearward into the bit holder 26. As the bit 28 slides rearward, it engages the flexible arms of the bit holder 26. As the bit 28 engages the flexible arms of the bit holder 26 the inwardly biased flexible arms engage the exterior surface of bit 28 are forced to expand as the bit 28 slides into the bit holder 26. The rearward progression of bit 28 within bit holder 26 is stopped when the rearward end of bit 28 engages a step 110 positioned at the rearward end of recess 108, which establishes that the bit 28 is fully inserted within the bit holder 28. In this position, the engagement of the flexible arms onto the exterior surface of the bit 28 holds the bit 28 within the bit holder 26.

Alternatively, bits 28 can be inserted within bit holders 26 by aligning the bit 28 with the bit holder 26 and forcing the bit 28 downward into the bit holder 26. As the bit 28 is forced downward, the flexible arms of bit holder 26 engage the exterior surface of the bit 28 and they flex outward allowing the bit 28 to enter the bit holder 26. Once the bit 28 is within the bit holder 26, the flexible arms again bias inward in engagement with the exterior surface of the bit 28 and apply a force thereon thereby holding the bit 28 within the bit holder 26.

The bits 28 are similarly, but oppositely, removed from the bit holder 26. That is, in one arrangement, the bits 28 are be slid forward and away from step 110 until the flexible arms of bit holder 26 no longer engage the bit 28 thereby allowing the bit 28 to be used. Alternatively, bit 28 are pulled out of bit holder 26 by applying a force approximately perpendicular to the exterior surface of the main body 12 thereby forcing the flexible arms to flex outward and allow the bit 28 to escape the bit holder 26 thereby allowing the bit 28 to be used.

Again, bits 28 are formed of any suitable and generally conventional arrangement. In one arrangement, main body 12 holds approximately eight bits 28. However, any number of bits 28 are hereby contemplated for use such as one, two, three, four, five, six, seven, nine, ten, eleven, twelve or more. In addition, any configuration or combination of bits 28 may be used in system 10, including: Philips head bits, flat head bits, hex head bits, square head bits, pentagon head bits, external torx head bits, 12-point bits, cross head bits, slotted bits, Frearson bits, French recess bits, Mortorq bits, Pozidriv bits, Supadriv bits, Robertson bits, Spanner head bits, double-square bits, triple square bits, Polydrive bits, spline drive bits or any other form of a bit or driver. Alternatively, socket driver bits can also be used such as small sized sockets attached to a bit driver that include a socket that receives and drives a nut.

Alternatively, bit holders 26 can be used to hold other objects that are useful for the particular application, such as replacement parts (such as screws, bolts, valve stems, seals, or any other replacement part) or repair supplies (such as glue, tape or any other repair supply).

Locking Mechanism:

The forward most end of main body 12 also includes a locking mechanism 32. Locking mechanism 32 is formed of any suitable size, shape and design and serves as a way of connecting cover 36 to main body 12. In one arrangement, as is shown, locking mechanism 32 includes an upwardly pointing tooth having a ramped forward surface 112 that extends upward at an angle as it extends rearward. Ramped forward surface 112 connects to a generally flat rearward surface 114 that is positioned in a generally vertical alignment or even slightly inwardly angled alignment.

Locking mechanism 32 of main body 12 is configured to engage and lock with locking mechanism 116 operably connected to button 118 of cover 36. That is, the upward and rearwardly angled ramped surface 112 allows the locking mechanism 32 of button 118 of cover 36 easily slide up and over the locking mechanism 32 of the main body 12. In contrast the relatively vertical or slightly inwardly angled rearward surface 114 of locking mechanism 32 serves to engage and hold the locking mechanism 116 of button 118 of cover 36. In this way, the locking mechanism 32 of main body 12 serves as a hook or a barb that allows cover 36 to fit over locking mechanism 32 while preventing unintentional removal of cover 32, as is further described herein.

In an alternative arrangement, cover 36 connects to main body 12 by any other manner, method or means. In one arrangement, button 118 is not present. Instead, in one arrangement, cover 36 connects to main body 12 by a frictional snap fit arrangement. In this arrangement, cover 36 and main body 12 include one or more locking features that engage one another and disengage from one another by friction fit direct engagement. In this arrangement, the user applies a force to overcome the frictional engagement between the parts to connect cover 36 to main body 12; and similarly, but in opposite fashion, the user applies a force to overcome the frictional engagement between the parts to remove the cover 36 from main body 12. In yet another alternative arrangement, cover 36 connects to main body 12 by a key-fit locking arrangement. In this arrangement, one of the cover 36 and/or main body 12 include one or more locking features that are inserted into or engaged with a slot, opening, hole or other keyed receiving member on the other of the cover 36 and/or main body 12. In this arrangement, the user inserts the features of one of the cover 36 and/or main body 12 into the other of the cover 36 and/or main body 12 and twists the cover 36 with respect to the main body 12 thereby locking the two components together. The opposite process is performed to remove cover 36 from main body 12. In yet another alternative arrangement, cover 36 connects to main body 12 by a treaded arrangement. In this arrangement, the cover 36 and main body 12 include threaded features that engage one another thereby connecting the two components together. In this arrangement, the user places the cover 36 over the main body 12 thereby engaging the threaded features of both components and then the user twists the cover 36 with respect to the housing 12 thereby locking the two components together. The opposite process is performed to remove cover 36 from main body 12. Cover 36 and main body 12 are connectable and removable from one another by any other manner, method or means.

Cover:

Cover 36 is formed of any suitable size, shape and design and serves a number of purposes including covering the main body 12 and bits 28, serving as a holding device for driver 30 and serving as a handle to rotate driver 30 when in use. In one arrangement, cover 36 includes a generally cylindrical or tubular body having an exterior surface 120 that extends between a rearward end 122 to a forward end 124 and defines a hollow interior 126. The exterior surface 120 is generally smooth and cylindrical, however in one arrangement, as is shown, the exterior surface 120 includes a plurality of features 128 that help to improve grip when in use such as ribbing, recesses, bulges, ridges or the like. Also, in the arrangement shown, the cylindrical exterior surface 120 smoothly transitions to a rounded end at forward end 124. The smooth exterior surface 120 and rounded forward end 124 eliminates sharp edges and reduces the potential that the cover will get caught on or hung up by a user's clothing thereby improving the safety of the device.

The exterior surface 120 of cover 36 includes an opening 128 therein that is configured to receive button 118. Opening 128 is formed of any suitable size, shape and design and is configured to house and hold button 118 and to allow button 118 to operate locking mechanism 116 of cover 36 such that the locking mechanism 116 of cover 36 engages with and disengage from locking mechanism 32 of main body 12.

In the arrangement shown, button 118 is generally rectangular in shape when viewed from above or below and extends between a forward edge 130, a rearward edge 132 and opposing sides 134. The upper surface 136 of button 118 arcuately curves downward slightly toward the forward edge 130 and also includes a recess 138 positioned toward the rearward edge 132 of button 118. Indicia 140, or markings, are also positioned in the upper surface 136 of button 118 and provide information as to how the button 118 operates. In one arrangement, as is shown, indicia 140 include a rearward pointing arrow positioned near the rearward edge 132 of button 118 and a forward pointing arrow positioned near the forward edge 130 of button 118 which indicate where, how or which way the button 118 should be pressed to accomplish attachment of cover 36 to main body 12 or removal of cover 36 to main body 12.

The lower end of button 118 includes a bore 142 that extends there through from side 134 to side 134. Bore 142 is positioned at the middle of button 118 between forward edge 130 and rearward edge 132 and serves as a fulcrum or pivot point for button 118 to pivot on. Cover 36 similarly include bore 144 that extends through cover 36 at the sides of opening 128. When button 118 is in position within opening 128, bore 142 of button 118 aligns with bore 144 of cover 36 and an axle 146 extends there through thereby pivotally holding button 118 within opening 128 of cover 36.

In one arrangement, to apply a bias force to button 118 a compression spring 148 is connected to button 118. In one arrangement, compression spring 148 is positioned around axle 146 and applies a force that helps to maintain the rearward edge 132 of button 118 toward main body 12 thereby preventing unintentional disengagement of cover 36 from main body 12 while allowing a user to overcome the bias force to install cover 36 on main body 12 or remove cover 36 from main body.

Locking mechanism 116 of cover 36 may be formed of any suitable size, shape and design to serve the function of allowing installation of cover 36 onto main body and removal of cover 36 from main body. In the arrangement shown, as one example, locking mechanism 116 of cover 36 is formed of an L-shaped member that is connected to or formed as part of button 118. The L-shaped member include a generally flat and vertical rearward face and forward face that extend in approximate parallel spaced relation to one another and connect at a rounded lower edge.

Installation:

When cover 36 is installed onto main body 12, the generally vertical rearward face and rounded lower edge of locking mechanism 116 engage the upward and rearward angled ramped forward surface 112 of locking mechanism 32 of main body 12. As the cover 36 is forced toward the main body 12, the generally vertical rearward face and rounded lower edge of locking mechanism 116 slid upward and over rearward angled ramped forward surface 112 of locking mechanism 32 of main body 12 as button 118 pivots on axle 146 against the bias force of spring 148. Once the rounded lower edge of locking mechanism 116 passes the ramped forward surface 112 of locking mechanism 32 the L-shaped member of locking mechanism 116 is automatically forced downward by the bias force of spring 148 thereby locking cover 36 onto main body 12. In this position, the generally flat vertical or even slightly inwardly angled rearward face 114 of the locking mechanism 32 of main body 12 is in generally flat and flush engagement with the generally flat vertical face on the forward side of the L-shaped member of locking mechanism 116. Due to this generally flat and flush engagement between the forward face of locking mechanism 116 and the rearward surface 114 of locking mechanism 32 the cover 36 is held in place on main body 12. In this position, even if substantial force was applied to pull cover 36 off of main body 12, the two components would remain together because there is motivation for the locking mechanism 116 to slide up and over the locking mechanism 32, this is especially true considering the bias force of spring 148 that forces the rearward end 132 downward.

Removal:

When it is desired to remove cover 36 from main body 12, a user applies downward pressure to the forward end of button 118. This causes the button 118 to pivot upon the pivot point formed by axle 146 and causes the rearward end of button 118 to rise. As the rearward end of button 118 rises, the L-shaped locking mechanism 116 of button 118 clears the locking mechanism 32 of main body 12. Once the locking mechanism 116 of button 118 clears the locking mechanism 32 of main body 12, the cover 36 can be pulled forward and removed from main body 12.

Driver:

Driver 30 is formed of any suitable size, shape and design and serves to removably receive bits 28. In one arrangement, as is shown, driver 30 extends a length from a rearward end 150 to a forward end 152. The rearward end 150 includes a socket 34 therein that is sized and shaped to removably receive a bit 28 therein such that as the driver 30 is rotated, so is the bit 28. The rearward end 150 of driver 30 extends a distance past the rearward end 122 of cover 36 thereby allowing for easier use of bit 28 when in use.

The forward end 152 of driver 30 is received within an opening or socket in the forward end 124 of cover 36. In one arrangement, the forward end 152 of driver 30 is permanently affixed to; press fitted within; or formed as a part of the forward end of cover 36 such that the driver 30 is non-removable from cover 26. In another arrangement, the forward end 152 of driver 30 is removably fitted within an opening or socket in the forward end of cover 36 such that the driver 30 can be easily removed from and reinserted into the cover 36.

When cover 36 is installed over main body 12, driver 30 extends within hollow bore 44. When in cover 36 is fully installed over main body 12, the rearward end 150 of main body 12 is positioned just a short distance forward from the forward most edge of head 47 of fastener 20.

In Operation:

Once system 10 is installed onto the handlebars of a bicycle 24 the system is stored in a convenient but out of the way place. When a tool is needed, such as the bicycle 24 breaks down, the user can quickly and easily remove cover 36 from main body 12 by pressing down on the forward side of button 118. This causes the locking mechanism 116 of cover 36 to raise up above the locking mechanism 32 of main body 12 allowing the user to pull the cover 36 forward and off of main body 12. Once the cover 36 is removed from the main body 12 this exposes the plurality of bits 28 held within bit holders 26. The user selects the appropriate bit 28 and removes it from the bit holder 26 by either sliding the bit 28 forward and out of the bit holder 26 or by pulling it perpendicular from the main body 12 and out of the bit holder 26. Once the bit 28 is removed from the main body 12 the bit 28 is installed in the socket 34 of driver 30 and the cover 36 is used as a handle to rotate driver 30 and bit 28.

Once the user is done using the bit 28 and driver 30 the user re-inserts the bit 28 into the bit holder 26 and the user re-installs the cover 36 over the main body 12. In doing so, the driver 30 fits within the hollow bore 44 of main body 12, and the locking mechanism 116 of cover 36 engages the locking mechanism 32 of main body 12 thereby holding cover 36 in place over main body 12.

Donut:

In one arrangement, the exterior diameter of cover 36 is intended to mimic the approximate diameter of the handle bars of conventional bicycles 24. In one arrangement, to prevent a gap being present between the end of the handle bars and the rearward end 122 of cover 36, a donut 154 is positioned around the main body 12 rearward of the rearward end 122 of cover 36. This donut 154 has an exterior diameter approximate to the exterior diameter of cover 36 and handle bars of bicycle 24 and fills the gap between the end of the handle bars and the beginning of the cover 36. In this way, donut 154 improves the aesthetic appearance of the system by eliminating a gap as well as improves the safety of the system by eliminating the gap that can catch on a user's clothing. The presence of this donut 154 also helps to seal the open rearward end 122 of cover 36 thereby preventing dirt, water and other contaminants from getting within cover 36.

Once installed, this arrangement ensures that a multi-purpose tool is never left behind when going on a ride. While the system is quite small in stature, as it is attached to the handle bars, it is not easily misplaced, lost or left behind and it can always be easily located, removed and used.

Light:

In one arrangement, cover 36 includes a power source 156 such as a battery and a light 158 and a switch 160 that activates light 158. In one arrangement, switch 160 is manually activated by a user when the light 158 is desired. In another arrangement, when cover 36 is removed from main body 12 switch 160 is activated and the light 158 is turned on. The presence of light 158 and power source 156 provided the added convenience of providing a light source to system 10 which can be extremely helpful when a problem occurs at night.

Advertising:

In one arrangement, the exterior surface 120 of cover 36 includes advertising 162 thereon. In one arrangement, when system 10 is in place on the handle bars of bicycle 24, advertising 162 is placed on the exterior surface 120 of cover 36. This generally cylindrical exterior surface 120 is perfect for being etched with a name or logo, for being painted or for housing a sticker. This advertising provides a great amount of cross branding opportunities for this product as a promotional item. Examples of advertising 162 include a sticker placed onto the exterior surface of main body 12, a logo or design which is painted onto the exterior surface of cover 36, a logo or design which is etched into the exterior surface of cover 36, or any other form of advertising.

Rotation Prevention:

To effectively work, the plug 14 moves forward and rearward with respect to the main body 12. To accomplish this, the plug 14 does not rotate as the fastener 20 is rotated. To help ensure the plug 14 remains stationary and does not rotate, fins, grooves or guides 210 may be placed on any of the ramped surfaces 52, 70, 87 of protrusion 48, plug 14 and/or wedge 16, respectively. These guides 210 may be an arrangement of mating ridges and corresponding grooves, they may be a plurality of fins or ridges, or they may be any other feature that helps to prevent rotation while allowing for forward to back sliding movement. Use of guides 210 helps to ensure that the plug 14 does not rotate when the fastener 20 rotates thereby ensuring that the plug 14 is laterally moved when fastener 20 is rotated thereby ensuring quick and easy installation and removal.

Not Limited to Bicycles:

While the system 10 is described herein as being used in association with the open end of handlebars of a conventional bicycle 24, the system 10 is not so limited. Any reference to use with handle bars of bicycles is merely one example of countless possible uses. It is hereby contemplated that the system 10 can be used in association with bicycles, motorcycles, snowmobiles, strollers, golf carts (powered and unpowered), frames of any kind, or any other mechanical device, object, or the like.

In another arrangement, system 10 can be installed in any object into which a hole can be drilled that can receive plug 14 and expansion mechanism 15. Examples include tables, bars, counter tops, fence posts, picnic tables, work benches, walls, or any other object. This allows the installation of a system 10 in any convenient position or place such as in an in-home bar, at a restaurant, in one's garage or “man cave” or any other convenient location.

Alternative Arrangement:

In an alternative arrangement plug 14 is replaced with a conventional nut 74 having a threaded bore 76 and perhaps an extended flange or a washer is added. In this alternative arrangement, expansion mechanism 15 is formed of an elongated cylindrical tube 164. Cylindrical tube 164 is formed of any compressible material such as rubber, plastic, gel, foam, composite, or any combination thereof, or the like. Cylindrical tube 164 has a generally smooth and cylindrical exterior surface that terminates in opposing ends that extend in approximate perpendicular alignment to the length of cylindrical tube 164. Cylindrical tube 164 includes a centrally positioned bore that extends from end to end through approximately the center of cylindrical tube 164. Also, in this arrangement, the rearward end of main body 12 includes a generally flat surface.

When assembled, the bore 44 of main body 12 aligns with the bore of cylindrical tube 164 which aligns with the threaded bore 76 of nut 74 and fastener 20 is inserted through the aligned bores and the fastener 20 is tightened.

As the nut 74 is pulled toward the main body 12 this causes the lateral length of cylindrical tube 164 to compress. This lateral compression causes the thickness of cylindrical tube 164 to expand. When inserted in the end of a bicycle handle bar or in a hole drilled into a bar or other opening, when the cylindrical tube 164 laterally compresses but increases in thickness, this causes the cylindrical tube 164 to bind to the interior surface of the handle bar or opening thereby preventing removal of main body 12.

By utilizing conventional parts, such as nut 74, and by simplifying the design, by using a cylindrical tube 164 as expansion mechanism 15, this alternative arrangement simplifies the design of the system 10 and thereby reduces the manufacturing cost of the system 10, simplifies the assembly process and eliminates the need for specialized parts and pieces as well as manufacturing steps.

While the term “nut” is used herein to describe the item presented as reference numeral 74, the term is to be broadly defined. That is the term nut (as used with respect to reference numeral 74) and the term plug (as used with respect to reference numeral 14) are to be used interchangeably herein unless specifically stated otherwise. That is, the terms nut and plug are meant to identify an item that is placed on the end 104 of fastener 20 that threadably receives the fastener 20 in a bore therein and serves to cause expansion mechanism to expand and contract when fastener 20 is rotated.

Battery Arrangement:

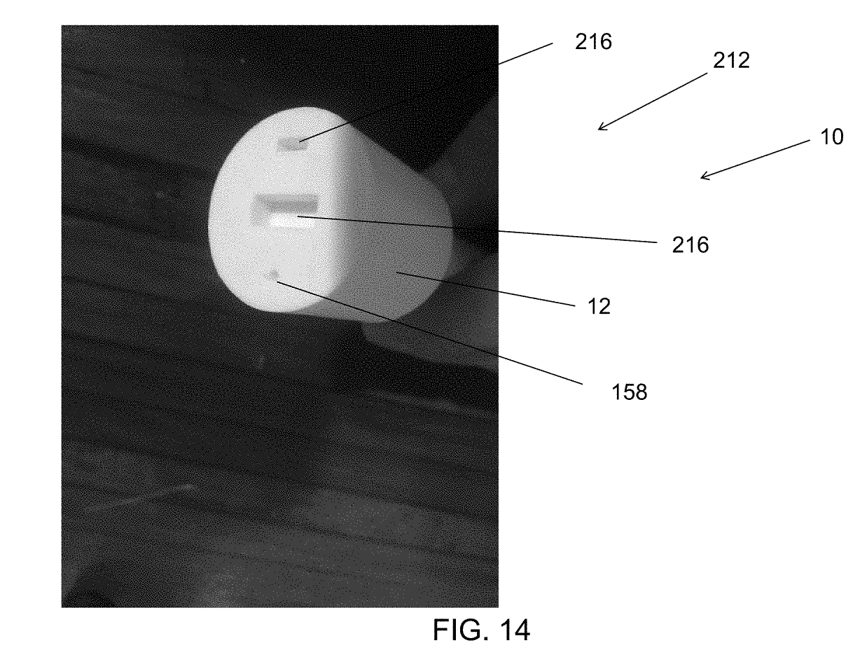

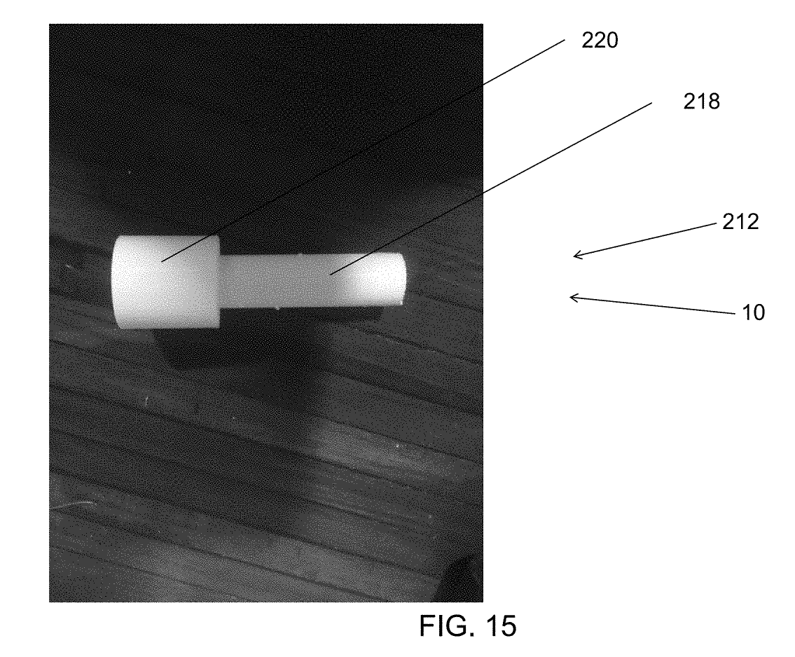

With reference FIGS. 14 and 15, another embodiment is presented that includes a battery arrangement 212 that replaces the main body 12 or is attached to main body 12. The battery arrangement 212 includes a battery 214 and at least one port 216, such as a conventional USB port, micro-USB port, or the like. Like main body 12, a portion of the main body 12 is inserted in the open end of the handle bars and thereby is maintained in a convenient place for a user to connect their cell phone or other electronic device. The battery arrangement 212 is connected to the handle bar by any manner or means, such as those discussed herein or other manners or means such as threading onto the exterior surface of the handle bar or the like.

In one arrangement, as is shown, the battery arrangement 212 includes a narrower section 218 that fits within the hollow tube of a handle bars. This narrower section 218 is connected to a larger diameter section 220 (much like the cover section 36 of the tool arrangement 10) that remains exterior to the hollow interior of the handle bars. The batteries may be contained within either or both of the narrower section 218 and the wider section 220. In one arrangement a solar cell connected to the system 10 and is connected to the batteries within the system 10. In the arrangement wherein a solar cell is used, the solar cell is positioned on the wider section 220 that remains exterior to the handle bars and therefore is exposed to charging sunlight. Since bicycles are often used outside, this solar cell is advantageous and can help reduce or eliminate the need to charge the battery.

This battery arrangement provides all the other advantages described herein with respect to the tool arrangement. That is, the battery arrangement is positioned in a relatively permanent manner, or a removable manner, or it is easily slid in and out of the opening in the handle bars with just enough to hold it therein without it unintentionally escaping. The battery arrangement 212 is positioned in a convenient but out of the way place and it provides a great amount of functionality for riders who need to charge their phone or other electronic device on long rides, and the like.

From the above discussion and the accompanying drawings and claims it will be appreciated that the handlebar mounted tool system and method of use presented offers many advantages over the prior art. That is, the handlebar mounted tool system and method of use presented; improves upon the state of the art; is convenient to use; is hard to misplace or leave behind; can easily be attached to various devices such as bicycles; is durable; has a long useful life; has an intuitive design; is formed of a minimum number of parts; has a rugged design; is light weight; is relatively inexpensive; provides value, utility and novelty to the user; can easily and efficiently be used in a convenient manner; is sized and shaped to be quickly and easily installed on conventional handle bars of bicycles; is adjustable; provides for a convenient place for advertising and promotion; can be easily removed and reinstalled, among countless other improvements and advantages.

It will be appreciated by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in light thereof will be suggested to persons skilled in the art and are to be included within the spirit and purview of this application.

What is claimed:

1. A tool system comprising:
a main body;
at least one bit held by the main body;
the at least one bit held by the main body in a removable manner;
an expansion mechanism;
the expansion mechanism operably connected to the main body;
the expansion mechanism configured to expand in diameter;
a cover;
the cover operably connected to the main body in a removable manner;
the cover having a driver;
the driver having a socket;
the socket configured to hold a bit;
wherein the tool system is configured to connect to an opening by inserting the expansion mechanism within the opening and expanding the diameter of the expansion mechanism.

2. The system of claim 1 further comprising a fastener that extends through the main body and the expansion mechanism.

3. The system of claim 2 wherein when the fastener is rotated in a first direction the expansion mechanism expands and wherein when the fastener is rotated in a second direction, opposite the first direction, the expansion mechanism contracts.

4. The system of claim 1 wherein the expansion mechanism is positioned within an open end of the handle bars of a bicycle.

5. The system of claim 1 wherein the expansion mechanism is formed of a plurality of wedges.

6. The system of claim 1 wherein the expansion mechanism is formed of a compressible cylindrical tube.

7. The system of claim 1 further comprising a plug threadably connected to an end of a fastener opposite the expansion mechanism.

8. The system of claim 1 further comprising a nut threadably connected to an end of a fastener opposite the expansion mechanism.

9. The system of claim 1 wherein the expansion mechanism is formed of a plurality of wedges with at least one binder placed around the wedges thereby holding the wedges together

10. The system of claim 1 wherein advertising is placed on an exterior surface of the cover.

11. A mountable tool system comprising:
a main body;
the main body having a plurality of bit holders;
the plurality of bit holders configured to hold a bit therein;
a cover;
the cover configured to be placed over and removed from the main body;
a driver connected to the cover;
the driver configured to receive a bit;
an expansion mechanism connected to the main body;
wherein the expansion mechanism is configured to expand in diameter thereby attaching the tool system to another structure, such as handle bars of a bicycle.

12. A tool system comprising:
a main body;
at least one bit held by the main body;
the at least one bit held by the main body in a removable manner;
a connection mechanism;
the connection mechanism operably connected to the main body;
a cover;
the cover operably connected to the main body in a removable manner;
the cover having a driver;
the driver having a socket;
the socket configured to hold a bit;
wherein the tool system is configured to connect to a structure having an opening by inserting the connection mechanism within the opening thereby holding the tool system to the structure.

13. The system of claim 12 wherein the connection mechanism imparts friction upon the structure thereby holding the system to the structure.

14. The system of claim 12 wherein the connection mechanism expands in diameter.

15. The system of claim 12 wherein the cover has a button that facilitates the removal of the cover from the main body.
